(19) United States
(12) Patent Application Publication
(10) Pub. No.: US 2007/0092764 A1
(43) Pub. Date: Apr. 26, 2007

(54) FUEL-CELL-DRIVEN ELECTRIC VEHICLE

(76) Inventor: Kenji Kobayashi, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/535,378

(22) Filed: Sep. 26, 2006

(30) Foreign Application Priority Data
Sep. 26, 2005 (JP) 2005-277290

(51) Int. Cl. H01M 16/00; H01M 8/02; H01M 8/04; B60L 11/18

(52) U.S. Cl. 429/9; 429/34; 429/26; 180/65.3

(57) ABSTRACT

A fuel-cell-driven electric vehicle can be provided on which the maintenance work can be performed easily without the need for removing the fuel-cell system from the vehicle body. A fuel-cell accommodating part with an opening and closing lid can be provided between a front wheel and a rear wheel on a vehicle body, and a fuel-cell system can be installed inside the fuel-cell accommodating part. A unit body having a secondary cell and a subframe can be detachably mounted above the fuel-cell accommodating part of the vehicle body so that an open space for the maintenance work is formed above the fuel-cell accommodating part once the unit body is dismounted from the vehicle body. Also, a radiator, a water pump, an air compressor, an air cleaner, and a hydrogen cylinder can be fixed to the vehicle body frame constituting the main body of the vehicle body.

### CROSS-REFERENCE TO RELATED APPLICATIONS

The present application is based on and claims priority under 35 U.S.C. § 119 to Japanese Patent Application No. 2005-277290, filed on Sep. 26, 2005, the entire contents of which is expressly incorporated by reference herein.

### BACKGROUND OF THE INVENTION

1. Field of the Invention

The present invention relates to a electric vehicles, and more specifically to a fuel-cell-driven electric vehicle utilizing the electric power generated by a fuel-cell system for operation.

2. Description of the Related Art

A conventional fuel-cell-driven electric vehicle that utilizes the electric power generated by a fuel-cell system for operation is disclosed, for example, in Japanese Publication No. JP 2001-130468. In the fuel-cell-driven electric vehicle disclosed in JP 2001-130468, a front frame, a center frame and a rear frame constitute a vehicle body frame, and a space with open sides and an open bottom is formed in the lower part of the center frame. A fuel cell is detachably mounted in this space.

However, since the fuel cell is disposed in the lower part of the vehicle body frame in the conventional fuel-cell-driven electric vehicle described above, the fuel-cell has to be dismounted from the vehicle body frame to perform maintenance work on the fuel-cell. In such cases, dismounting and mounting the fuel-cell from and onto the vehicle body frame is complicated and time-consuming, because various components are connected to the fuel cell via wiring and other connectors.

### SUMMARY OF THE INVENTION

In view of the circumstances above, an aspect of at least one of the embodiments disclosed herein is to provide a fuel-cell-driven electric vehicle that allows easy maintenance of a fuel cell without the need to remove the fuel-cell system from the vehicle body.

In accordance with an embodiment, a fuel-cell-driven electric vehicle utilizing the electric power generated by a fuel-cell system for operation is provided. The fuel-cell-driven electric vehicle comprises a fuel-cell accommodating part having an openable lid thereon, the fuel-cell accommodating part disposed between a front wheel and a rear wheel of a vehicle body of the fuel-cell-driven electric vehicle, the fuel-cell accommodating part configured to house a fuel-cell system therein. The fuel-cell-driven electric vehicle also comprises a secondary cell detachably mounted above the fuel-cell accommodating part of the vehicle body, the secondary cell dismountable from the vehicle body to define an open space above the fuel-cell accommodating part, the lid movable to an open position to allow access to the fuel-cell system therethrough.

In accordance with still another embodiment, a method for performing a maintenance operation on a fuel-cell-driven electric vehicle utilizing electric power generated by a fuel-cell system for operation is provided. The fuel-cell-driven electric vehicle has a vehicle body, a secondary cell, a fuel-cell accommodating part that houses a fuel cell therein and has a lid. The method comprises dismounting the secondary cell from the vehicle body to allow access to a fuel-cell accommodating part. The method also comprises opening the lid of the fuel-cell accommodating part to allow access to the fuel cell through an opening in the fuel-cell accommodating part and performing a maintenance operation on the fuel cell through the opening.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 6 figures.

FIG. 1 is a schematic perspective view of a motorcycle according to an embodiment.

FIG. 2 is a schematic side view of the motorcycle of FIG. 1.

FIG. 3 is a schematic top plan view of the motorcycle of FIG. 1.

FIG. 4 is a schematic front view of the motorcycle of FIG. 1.

FIG. 5 is a schematic perspective view showing the motorcycle of FIG. 1 after removing the unit body.

FIG. 6 is a block diagram showing components of the motorcycle.

### DETAILED DESCRIPTION OF THE PREFERRED EMBODIMENTS

As used in the following description, the terms “front,” “forward,” “rear,” “rearward,” “left,” “right,” “top,” “upper,” “bottom” and “lower” are defined from the perspective of user riding the fuel-cell-driven electric vehicle.

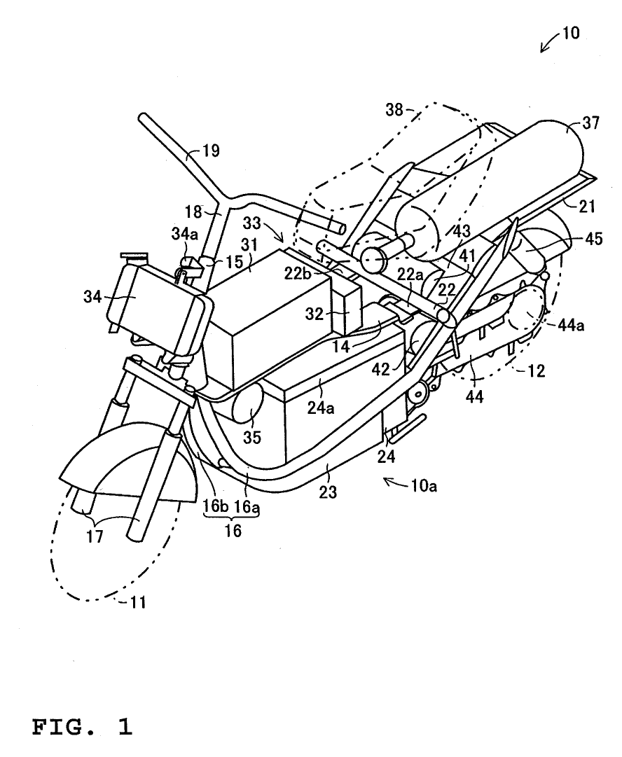

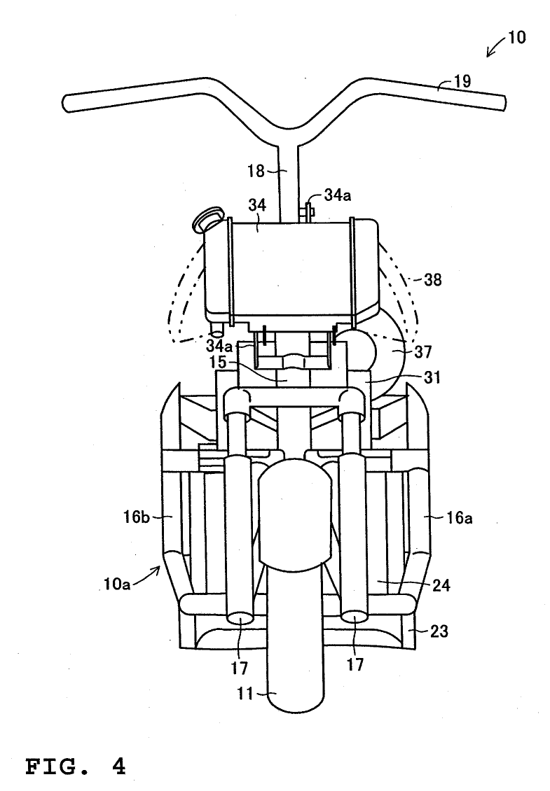

FIGS. 1-4 show a fuel-cell-driven electric vehicle according to the embodiment. In the illustrated embodiments, the fuel-cell-driven electric vehicle can be a motorcycle 10. The motorcycle 10 can be provided with a pair of wheels including a front wheel 11, a rear wheel 12, and a vehicle body 10a to which the wheels 11, 12 can be attached. The vehicle body 10a can also be provided with a vehicle body frame 13 constituting the major part of the vehicle body 10a, and a subframe 14 that can be detachably mounted to the vehicle body frame 13. In addition, the vehicle body frame 13 includes a head pipe 15 constituting the forward part of the vehicle body 10a, and a down tube 16 extending rearward from the head pipe 15.

The front wheel 11 can be rotatably supported at the lower end of a front fork 17 bifurcated in the lower part. That is, both lower ends of the front fork 17 rotatably support the central shaft of the front wheel 11 (not shown) from both sides to allow rotation of the front wheel 11 around the central shaft.

The upper end of the front fork 17 can be joined to the lower end of a steering shaft 18 disposed inside the head pipe 15. The steering shaft 18 can be mounted inside the head pipe 15 in the manner that the steering shaft 18 can turn around the axis of the head pipe 15, with the upper end of the steering shaft 18 protruding from the head pipe 15 and extending upward. In addition, the upper end of the steering shaft 18 can be joined to a handle 19.

Thus, as the steering shaft 18 is rotated about the axis of the head pipe 15 by the turning operation of the handle 19, the front wheel 11 changes its direction to both sides corresponding to the degree of rotation of the steering shaft 18. A grip (not shown) can be provided on both left and right ends of the handle 19. One of these grips can be provided in the manner that allows rotation around the axis of the grip, so that it can be not only used as a grip portion to be held by hand, but it also constitutes a manipulator for adjusting the rotational speed of a driving motor 44a described in greater detail below. On the other hand, the other grip can be fixed to the handle 19 to be used as a grip portion to be held by a hand of the user. In addition, a brake lever (not shown) can be provided in the vicinity of each grip, which can be urged away from the grip and works to restrict the rotation of the front wheel 11 or the rear wheel 12 when it is pulled toward the grip.

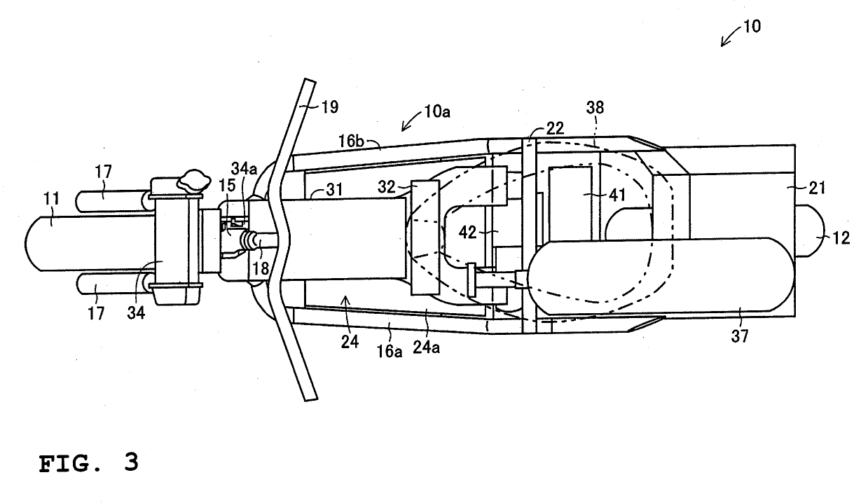

The down tube 16 includes a pair of main frames 16a, 16b that with their forward ends (upper ends) can be joined to either sides of the head pipe 15 at its lower part. Each of the main frames 16a, 16b extends downwardly and rearwardly from the junction with the head pipe 15. The distance between the main frames 16a, 16b increases (e.g., the main frames 16a, 16b flare outward away from the junction with the head pipe 15). The main frames 16a, 16b can also be bent to extend further rearwardly in the horizontal direction. Further, as best illustrated in FIG. 3, the rear end parts of the main frames 16a, 16b can extend upwardly toward the rear of the motorcycle 10 while keeping a substantially constant distance between them. The rear ends of the main frames 16a, 16b can be joined to a plate attaching member 21 that can be disposed horizontally.

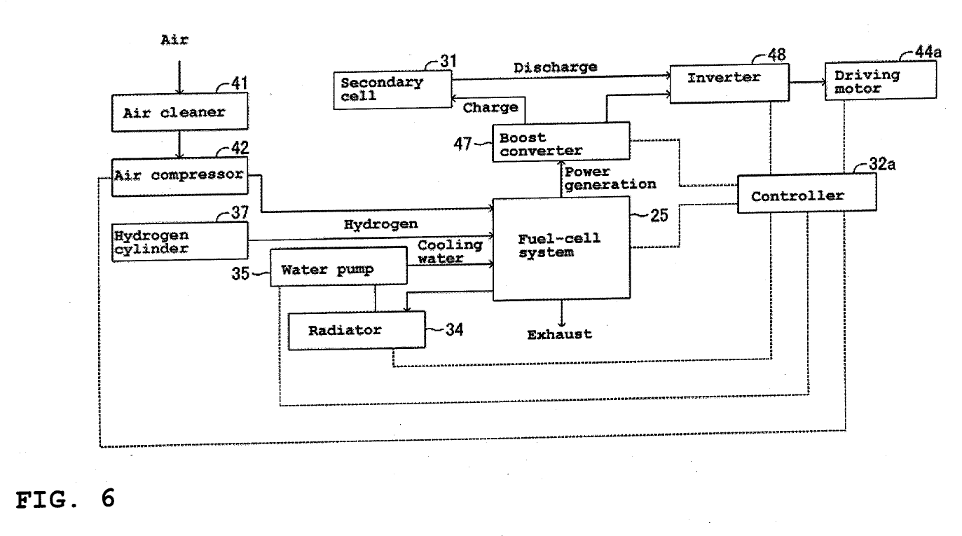

In addition, a cross member 22 can be laid across the upper faces in the rear part of the main frames 16a, 16b. The cross member 22 can be formed into a bar shape with its ends being bent generally at right angles. The bent parts at both ends can be joined to the main frames 16a, 16b, while the main part of the cross member 22 protrudes from (or extends above) the upper face of the main frames 16a, 16b. In addition, attaching pieces 22a, 22b, each having a screw hole, can be provided on both sides of the cross member 22. Also, a mounting board 23 protrudes below the lower ends of the main frames 16a, 16b. The top face of the mounting board 23 forms a cavity, which can be concave, in which a fuel-cell accommodating part 24 can be mounted. The fuel-cell accommodating part 24 can be constructed as a box having a lid 24a that can be opened and closed. A fuel-cell system 25 (See FIG. 6) can be accommodated in the fuel-cell accommodating part 24. In one embodiment, the fuel-cell system 25 can be a device that includes power generation equipment.

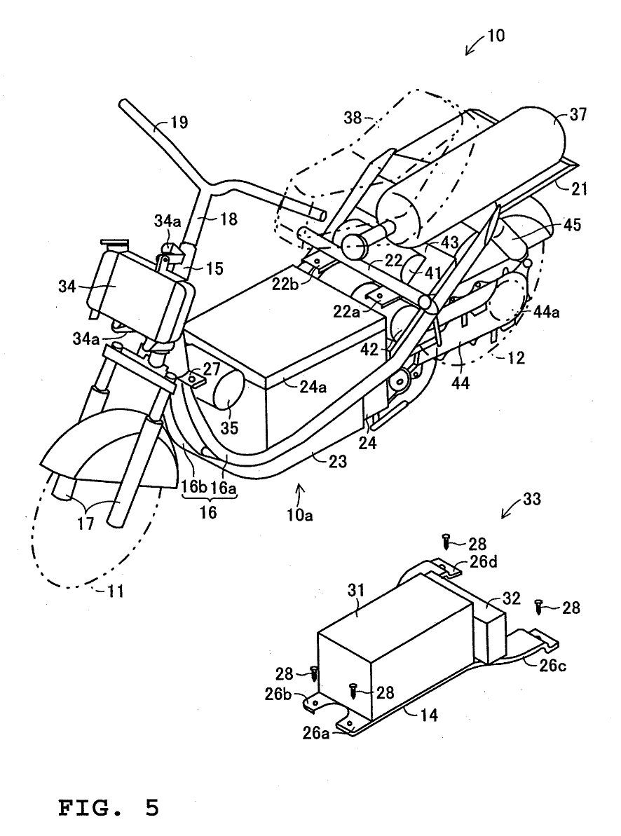

The plate subframe 14 can be mounted between the forward part of the down tube 16 and the cross member 22 provided in the rear part of the down tube 16. As shown in FIG. 5, the subframe 14 can have attaching pieces 26a, 26b, 26c, 26d, provided on both sides at the forward end, and on both sides at the rear end of the subframe 14, each of the attaching pieces 26a, 26b, 26c, 26d having a screw hole and protruding forward or rearward. In addition, a plate attaching piece 27 having a screw hole can be provided each on the left and right sides of the upper front part of the down tube 16. The forward end of the subframe 14 can be coupled to the forward part of the down tube 16 by tightening mounting bolts 28 in a pair of screw holes on the left and right sides after aligning the screw holes on the attaching piece 26a, 26b, and those on the attaching piece 27.

The rear end of the subframe 14 can be coupled to the rear part of the down tube 16 by tightening the mounting bolts 28 in the pair of screw holes after aligning the screw holes on the attaching pieces 26c, 26d, with the corresponding screw holes on the attaching pieces 22a, 22b. In addition, a secondary cell 31 can be mounted on top of the subframe 14 at a position forward of its center. A control unit 32 can be coupled to the top of the subframe 14 rearward of the secondary cell 31. The subframe 14, the secondary cell 31, and the control unit 32 can be assembled integrally to form a unit body 33. In some embodiments, the secondary cell 31 can be a rechargeable stand-by battery.

Thus, the fuel-cell system 25 in the fuel-cell accommodating part 24 can be exposed once the unit body 33 is dismounted from the vehicle body 10a and the lid 24a of the fuel-cell accommodating part 24 is lifted open thereby allowing maintenance work to be performed on the fuel-cell system 25. That is, the space for installing the unit body 33 becomes an open space for the maintenance work once the unit body 33 is dismounted. In some embodiments, the length of the unit body 33 along the vehicle body can be smaller than the length of the fuel-cell accommodating part 24 along the vehicle body. Maintenance work can include, for example, but without limitation the inspection of leaks and improper connection regarding the pipes of each component connected to the fuel-cell system 25.

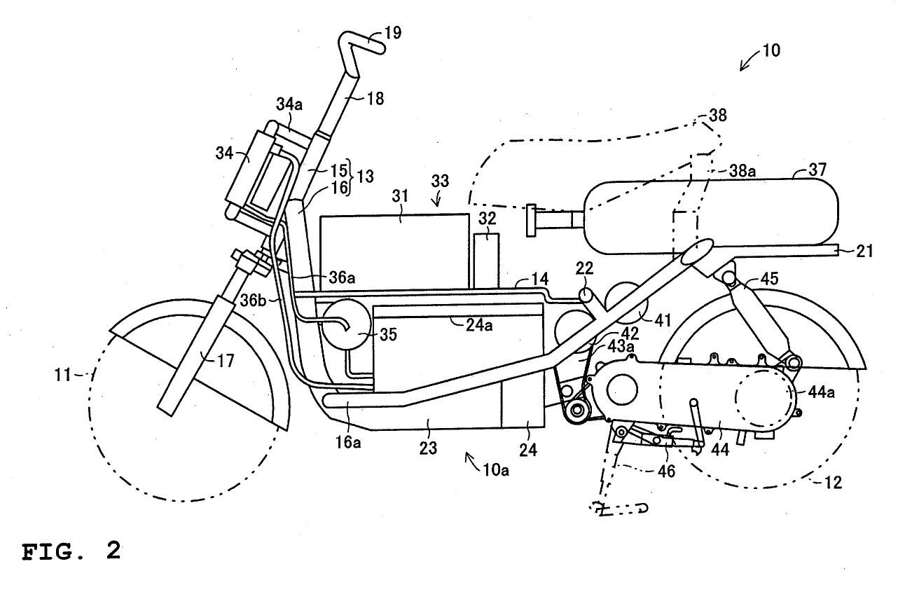

As illustrated in FIG. 2, a radiator 34 can be installed in front of the head pipe 15 using a fastening member 34a. A water pump 35 can be installed in front of the fuel-cell accommodating part 24 and below the subframe 14 (the secondary cell 31).

The radiator 34 and the water pump 35 can be connected by the outgoing portion of a cooling water pipe 36a. The cooling water pipe 36a can extend further from the water pump 35 toward the fuel-cell accommodating part 24, enter into the fuel-cell accommodating part 24 through the front face of the fuel-cell accommodating part 24, and can connect to the fuel-cell system 25. The cooling water pipe 36a extends from the radiator 34 to the fuel-cell system 25, running along the down tube 16 and below the subframe 14.

A return portion of the cooling water pipe 36b can extend from the fuel-cell system 25 to the radiator 34 through the front face of the fuel-cell accommodating part 24. The cooling water pipe 36b can also be positioned below the subframe 14 and along the down tube 16. Thus, the operation of the water pump 35 provides cooling water from the radiator 34 to the fuel-cell system 25 by way of the cooling water pipe 36a to cool down the fuel-cell system 25. After absorbing the heat while cooling down the fuel-cell system 25, the cooling water can be returned to the radiator by way of the cooling water pipe 36b and can be cooled down as it flows through the radiator 34.

With continued reference to FIG. 2, a hydrogen cylinder 37, which can be filled with hydrogen to be delivered to the fuel-cell system 25 and serve as a hydrogen storage container, can be installed on the top face of the attaching member 21 coupled to the rear end of the main frames 16a, 16b. The hydrogen cylinder 37 can be coupled to the fuel-cell system 25 in the fuel-cell accommodating part 24 by way of a gas pipe (not shown), for delivering hydrogen gas to the fuel-cell system 25 through the gas pipe.

A seat 38 can be disposed above the forward part of the hydrogen cylinder 37. The seat 38 can be joined to the rear part of the down tube 16 via a supporting member 38a.

An air cleaner 41 can be installed rearward of the cross member 22, while an air compressor 42 can be installed in front of the cross member 22. In addition, a mounting board 43 can be provided between the main frames 16a, 16b in the rear part of the down tube 16. The air cleaner 41 and the air compressor 42 can be coupled to the down tube 16 by way of the mounting board 43.

A gas pipe (not shown) can be installed to connect the air cleaner 41 and the air compressor 42, as well as the air compressor 42 and the fuel-cell system 25, respectively. The air compressor 42 can operate to draw-in ambient air by way of the air cleaner 41 and deliver it into the fuel-cell system 25. Foreign matters mixed in the ambient air can be withdrawn from the air as the air passes through the air cleaner 41. In addition, a rear arm with a pair of arm members (not shown) extending rearwardly can be joined to the lower rear part of the down tube 16 via a connecting member 43a.

Further, the central shaft of the rear wheel 12 can be rotatably supported from both sides by the rear end of both arm members of the rear arm to allow rotation of the rear wheel 12 around its central axis. A motor unit 44 can be installed to one of the arm members of the rear arm on its outer face so as to cover the arm member. The motor unit 44 accommodates a driving motor 44a that operates with the electricity generated by the fuel-cell system 25, and reduction gears. The operation of the driving motor 44a makes the rear wheel 12 rotate to propel the motorcycle 10.

Shock absorbers 45 can be placed across the rear ends of the down tube 16 and the upper rear ends of the rear arm respectively. The rear ends of the rear arms can be structured to allow a swinging motion of the arms via the expansion and contraction of the shock absorbers 45. In addition, a drum brake (not shown) can be installed on the inside of the motor unit 44. The driving motor 44a can operate in proportion to the degree the grip in the handlebar 19 is turned under the control of a controller 32a included in the control unit 32, to automatically generate the driving force on the rear wheel 12. In some embodiments, the driving motor 44a ceases its operation under the control of the controller 32a when the brake lever is activated.

With continued reference to FIG. 2, the motorcycle 10 can be provided with a rotary stand 46 for keeping the motorcycle 10 in the stand-up condition while it is in the stationary state. While the motorcycle 10 is running, the stand 46 can be maintained in the raised position as illustrated by the solid line in FIG. 2. While the motorcycle 10 is at rest, the stand 46 can be set in the lowered position as illustrated by the chain double-dashed line in FIG. 2 to support the motorcycle 10 in a stationary position. Further, the control unit 32 can be provided with a boost converter 47 and an inverter 48 as shown in FIG. 6.

The fuel-cell system 25 can be configured to cause a reaction of the oxygen in the air delivered by the air compressor 42 with the hydrogen delivered by the hydrogen cylinder 37 to generate water as well as electricity. The boost converter 47 can be configured to boost the electricity (e.g., voltage) generated by the fuel-cell system 25 and to send it to the inverter 48 or sends it to the secondary cell 31 for charging the secondary cell 31. When necessary, the secondary cell 31 discharges electricity to the inverter 48 to be used as auxiliary power. The inverter 48 changes DC electricity generated by the fuel-cell system 25 or DC electricity delivered by the secondary cell 31 into AC electricity.

The controller 32a controls the water pump 35, the air compressor 42, the driving motor 44a and so on in accordance with the manipulation of the grip on the handlebar 19 by the operator, the predetermined program, and so on. Note that, although not shown in the drawings, the motorcycle 10 can be provided with a cover member to cover the exterior of the given parts so that each device including the radiator 34 and the hydrogen cylinder 37 is not visible from the outside to assure the desired aesthetics of the design. The motorcycle 10 can also be provided with the power switch (not shown) for starting the motorcycle 10.

In the arrangement described above, during operation, the operator first sits on the seat 38 with the knees apart when he or she gets on the motorcycle 10. Since the length of the unit body 33 positioned under the operator's crotch can be smaller along the vehicle body width than the length of the fuel-cell accommodating part 24 along the vehicle body width, the operator can sit on the seat 38 in a comfortable posture without the need for spreading out the legs widely.

Next, the operator turns on the power switch. This action starts the air supply to the fuel-cell system 25 from the air compressor 42. The hydrogen can be supplied to the fuel-cell system 25 from the hydrogen cylinder 37, and the fuel-cell system 25 generates electricity by reacting the oxygen in the air with the hydrogen.

Additionally, during operation, the fuel-cell system 25 can be cooled down and kept at the prescribed temperature by the cooling water delivered by the water pump 35. Also, the fuel-cell system 25 releases the water generated by the reaction of oxygen with hydrogen into the environment along with the exhaust.

As noted above, the operator can manipulate the grip to generate and send a torque or power request for accelerating the motorcycle to the desired speed. This action causes the controller 32a to activate the driving motor 44a, and the driving force can be generated on the rear wheel 12. On the other hand, the operator can also manipulate the brake bar as desired to reduce the running speed of or stop the motorcycle 10. This action causes the motorcycle 10 to decelerate to the extent the brake bar was manipulated. To cease the running of the motorcycle 10, the operator turns off the power switch and maintains the motorcycle 10 in the stand-up condition by turning the stand 46 to the lowered position to put it in contact with the ground.

When the need for the maintenance work on the fuel-cell system 25 arises, each mounting bolt 28 can be removed, and the unit body 33 can be dismounted from the vehicle body 10a as shown in FIG. 5. Then, the lid 24a of the fuel-cell accommodating part 24 can be lifted to open the fuel-cell accommodating part 24 and the maintenance work can be performed on the fuel-cell system 25 through the opening in the fuel-cell accommodating part 24. In this way, the fuel-cell system 25 can be worked on while it is accommodated in the fuel-cell accommodating part 24 without disconnecting any pipe. Also, a trial-run for the motorcycle 10 can be carried out while the motorcycle 10 is in a standing position during the maintenance process.

Thus, the open space for the maintenance work can be formed above the fuel-cell accommodating part 24 by dismounting the unit body 33 installed above the fuel-cell accommodating part 24 from the vehicle body 10a when the maintenance work is performed on the fuel-cell system 25. Then, lifting the lid 24a of the fuel-cell accommodating part 24 to an open position to allow access to the fuel-cell accommodating part 24, the maintenance work on the fuel-cell system 25 can be performed through the open space above the fuel-cell accommodating part 24. Consequently, maintenance work can be simplified because there is no need to remove the fuel-cell system 25 from the vehicle body 10a to perform the maintenance work, and the trial-run of the motorcycle 10 can be carried out as the maintenance process is performed.

In addition, installation of the heavy fuel-cell system 25 on the bottom part of generally the center of the vehicle body 10a in the vehicle's longitudinal direction can improve the weight balance of the vehicle body 10a. Further, the installation of the heavy secondary cell 31 above the fuel-cell system 25 results in the positioning of the secondary cell 31 between the front wheel 11 and the rear wheel 12 of the vehicle body 10a. The possible weight imbalance of the vehicle body 10a due to the installation of the secondary cell 31 can be prevented by this arrangement.

In addition, since the unit body 33 can be supported by the subframe 14 detachably mounted to the down tube 16, the secondary cell 31 and the control unit 32 can be dismounted from the vehicle body 10a together with the subframe 14. This makes it easier for the secondary cell 31 to be mounted to and dismounted from the vehicle body 10a. Further, the vehicle body 10a as a whole can have more rigidity by assembling the subframe 14 to the down tube 16. The rigidity of the down tube 16 can be further improved by the cross member 22 laying across the rear parts of the main frames 16a, 16b.

Also, as various on-board devices, including the radiator 34, the water pump 35, the air cleaner 41, the air compressor 42 and the hydrogen cylinder 37 can be coupled to the vehicle body frame 13, the fuel-cell system 25 can be put into operation while the unit body 33 is dismounted from the vehicle body 10a. This enables the practice of maintenance work while carrying out trial-runs or other testing. According to some embodiments described above, the maintenance work can be performed on the fuel-cell system 25 without removing any parts including cooling water pipes 36a, 36b, the disconnection of which takes much time and labor. This is useful for preventing the possible water leak while removing the cooling water pipes 36a, 36b.

Further, the radiator 34 and the water pump 35 can be positioned in the forward part of the vehicle body 10a in a compact manner. This allows the use of shorter cooling water pipes 36a, 36b for connecting the radiator 34 and the fuel-cell system 25. In addition, the installation of the cooling water pipes 36a, 36b below the secondary cell 31 and the fuel-cell accommodating part 24 reduces or eliminates the risk of possible damage to electric and other parts due to a possible short circuit caused by water leakage. The installation of the hydrogen cylinder 37 in the upper rear part of the vehicle body 10a can allow the discharge of hydrogen to the outside of the vehicle body 10a utilizing the wind generated during operation of the motorcycle 10 in the event of a hydrogen leak from the hydrogen cylinder 37. Thus, accumulation of the hydrogen in a part of vehicle body 10a can be prevented.

Additionally, the installation of the air compressor 42 in a position below the hydrogen cylinder 37 and rearward of the fuel-cell accommodating part 24 reduces or eliminates the risk of the possible absorption of hydrogen into the air compressor 42 below, if hydrogen leaks from the hydrogen cylinder 37. Consequently, an air/fuel ratio error due to the absorption of the hydrogen into the air compressor 42 can be reduced or eliminated. Also, the installation of the air compressor 42 rearward of the fuel-cell accommodating part 24 allows the use of a shorter gas pipe for connecting the air compressor 42 and the fuel-cell accommodating part 24, which additionally can result in a reduction of pressure loss in the gas piping.

The installation of the seat 38 above the hydrogen cylinder 37 can result in the positioning of the air compressor 42 remotely below the operator sitting on the seat 38. This can help reduce the volume of the operating sound of the air compressor 42 perceived by the operator, thereby reducing the likelihood that this sound would be a nuisance to the operator. Further, the smaller length of the unit body 33 along the vehicle body width in comparison with the length of the fuel-cell accommodating part 24 along the vehicle body width allows the operator to take more comfortable posture when sitting on the seat 38.

The present inventions are not limited to the aforementioned embodiments. Rather, the embodiments disclosed above can be modified for implementation as deemed to be appropriate. For instance, the fuel-cell-driven electric vehicle in some of the aforementioned embodiments can be the motorcycle 10. However, the fuel-cell-driven electric vehicle can also be a motor three-wheeler or may be a motor four-wheeler. Further in some of the aforementioned embodiments, the secondary cell 31 can be assembled into the unit body 33 to be mounted and dismounted from the vehicle body 10a together with the subframe 14. However, this may be arranged to remove only the secondary cell 31, while the subframe 14 can be kept on the vehicle body 10a. In this case, the subframe 14 can be formed not into a plate but into a frame or the like, so that the hands of an operator can be placed though the frame to access the fuel cell system 25. Also in some of the aforementioned embodiments, the hydrogen storage container is constructed by the hydrogen cylinder 37. However, the hydrogen storage container can be constructed by other device than a cylinder, so far as the hydrogen can be stored in it.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A fuel-cell-driven electric vehicle utilizing electric power generated by a fuel-cell system for operation, comprising;
a fuel-cell accommodating part having an openable lid thereon, the fuel-cell accommodating part disposed between a front wheel and a rear wheel of a vehicle body of the fuel-cell-driven electric vehicle, the fuel-cell accommodating part configured to house a fuel-cell system therein; and
a secondary cell detachably mounted above the fuel-cell accommodating part of the vehicle body, the secondary cell dismountable from the vehicle body to define an open space above the fuel-cell accommodating part, the lid movable to an open position to allow access to the fuel-cell system therethrough.

2. The fuel-cell-driven electric vehicle of claim 1, wherein the vehicle body comprises a vehicle body frame and a subframe detachably mounted to the vehicle body frame and extending in fore-and-aft direction above the fuel-cell accommodating part, the secondary cell being attached to the subframe.

3. The fuel-cell-driven electric vehicle of claim 2, wherein the vehicle body frame has a head pipe joining a handle at its upper end while rotatably supporting a steering shaft joining the front wheel via a connecting member at its lower end, and a down tube having a pair of members extending from the head pipe slanting downwardly to the rear, then extending generally horizontally to the rear passing through the left and right sides of or below the fuel-cell accommodating part and further slanting upwardly to the rear, with the subframe bridging the forward part and the rear part of the down tube.

4. The fuel-cell-driven electric vehicle of claim 3, additionally comprising a cross member extends across the pair of members constituting the down tube at the rear part of the down tube, a pair of left and right attaching portions disposed in the rear part of the subframe, the attaching portions being detachably fastened to both sides of the cross member.

5. The fuel-cell-driven electric vehicle of claim 2, additionally comprising a cooling system comprising a radiator and a water pump coupled to the vehicle body frame;
components for cooling the fuel-cell system;
an air compressor and an air cleaner constituting an air system component for delivering air to the fuel-cell system; and
a hydrogen storage container constituting a hydrogen system component for delivering hydrogen to the fuel-cell system.

6. The fuel-cell-driven electric vehicle of claim 5, wherein the secondary cell is disposed forward of the fuel-cell accommodating part, the radiator is disposed in front of the vehicle body frame, the water pump is installed in front of the fuel-cell accommodating part and below the secondary cell, an outgoing part of a cooling water pipe connecting the radiator and the fuel-cell system is routed from the radiator along the vehicle body frame to the water pump and further routed from the water pump through the area below the subframe and connected to the fuel-cell system via a front face of the fuel cell accommodating part, and wherein a returning part of the cooling water pipe is routed from the fuel-cell system via the font face of the fuel-cell accommodating part along the vehicle body frame to the radiator.

7. The fuel-cell-driven electric vehicle of claims 5, wherein the hydrogen storage container is disposed in an upper rear part of the vehicle body frame.

8. The fuel-cell-driven electric vehicle of claim 7, additionally comprising a seat removably positioned above the hydrogen storage container and wherein the air compressor is disposed below the hydrogen storage container and rearward of the fuel-cell accommodating part.

9. The fuel-cell-driven electric vehicle of claim 2, wherein the secondary cell and the subframe constitute a unit body configured to be mounted to or dismounted from the vehicle body simultaneously, the length of the unit body along the vehicle body width being smaller than the length of the fuel-cell accommodating part along the vehicle body width.

10. The fuel-cell-driven electric vehicle of claim 1, wherein the fuel-cell-driven electric vehicle is a motorcycle, a motor three-wheeler, or a motor four-wheeler.

11. A method for performing a maintenance operation on a fuel-cell-driven electric vehicle utilizing electric power generated by a fuel-cell system for operation, the fuel-cell-driven electric vehicle having a vehicle body, a secondary cell, a fuel-cell accommodating part that houses a fuel cell therein and has a lid, the method comprising:
dismounting the secondary cell from the vehicle body to allow access to a fuel-cell accommodating part;
opening the lid of the fuel-cell accommodating part to allow access to the fuel cell through an opening in the fuel-cell accommodating part; and
performing a maintenance operation on the fuel cell through the opening.

12. The method of claim 11, wherein performing a maintenance operation includes inspecting for leaks and improper connection of pipes to the fuel cell.

13. The method of claim 11, wherein performing a maintenance operation includes performing a trial run of the fuel-cell-driven electric vehicle while the vehicle is stopped.

14. The method of claim 11, wherein the secondary cell is a battery.
